(19) United States
(12) Patent Application Publication
(10) Pub. No.: US 2018/0058681 A1
(43) Pub. Date: Mar. 1, 2018

(54) 180 DEGREE LIGHT

(71) Applicants: Ammon Arave, Bunkerville, NV (US); Russell Hughes, Mesquite, NV (US)

(72) Inventors: Ammon Arave, Bunkerville, NV (US); Russell Hughes, Mesquite, NV (US)

(21) Appl. No.: 15/251,422

(22) Filed: Aug. 30, 2016

(51) Int. Cl. F21V 33/00; F21L 4/02

(52) U.S. Cl. CPC F21V 33/0008; F21V 23/0414; F21L 4/02

(57) ABSTRACT

A 180 degree light that includes a belt for wear around a persons head or waist whereto is releasably mounted band that mounts an array of individual LED lights arranged in a straight line, that are equally spaced apart, where the individual LED lights are battery powered to illuminate an area ahead of and off to the sides of the wearer, forming approximately a half circle of light projected outwardly, and includes a sleeve that is attached to the belt, back from the stip ends to maintain the battery that includes a button switch that the wearer operates with their finger to turn the array of LED lights on and off.

This application was filed as two Provisional Applications Nos. 62/221,326 and 62/219,524 for a “180 DEGREE BELT LIGHT” and a “180 DEGREE Head Light”, Sep. 21, 2015 and Sep. 16, 2015, that priority of the present application is hereby claimed for.

### BACKGROUND OF THE INVENTION

### Field of the Invention

A 180 degree LED light that includes a strip of individual LED lights arranged side by side on a strip that is mounted onto a band for coupling onto a belt for wear by a person mounted around their waist or head where, when the individual LED lights are lit they will provide illumination to an area of approximately a half circle in front of the wearer.

### Prior Art

The invention is in a battery operated LED light consisting of a strip of individual LED lights mounted to a belt worn around a person's head or waist to provide illumination of an area of approximately 180 degrees to the front of the person to illuminate a path, trail, or the like, that the wearer is walking, bicycling or riding on. Heretofore, belt and head band lights have incorporated a spot light or a group of lights that provide a cone shaped illumination to the front of a wearer only, that does not illuminate the sides of the wearer's and requires a lifting or lowering of the spot light to illuminate near and far distances ahead of the wearer. Where such head lights have utilized an LED light or grouping of LED lights, the illumination they provide has been frontal only. Within the knowledge of the inventions, prior lighting arrangement have not provided a belt or head band mounting a side by side arrangement of LED lights to both illuminate the wearer's path in a half circle that provided for near and far illumination, as does the invention.

### SUMMARY OF THE INVENTION

It is a principal object of the present invention to provide a strip of LED lights that are mounted to head or waist band where the strip of LED lights are powered by a battery, such as a cell phone type battery, that is fitted into a sleeve secured to a rear or side of the head or waist band and is electrically connected to the strip of LED lights, and where the battery is activated by a push button switch maintained on the outer surface of a battery housing for easy access by the wearer.

Another object of the present invention is to provide a strap that incorporates electrically connected LED lights arranged side by side on a strip that is for releasable attachment to the head or waist band that, when turned on, will illuminate approximately 180 degrees in front of the head or waist band wearer, such that the light from the LED lights will move naturally, without appreciable bounce, with the movement of the wearer.

The invention is in a strip of LED lights belt whose length is adjustable to connect around a forward half of a waist or head band that is length adjustable to fit around the head or waist of a wearer. The strip mounts a number of side by side electrically connected LED lights that are connected to a battery, such as a cell phone battery, that is maintained in a holder connected to the rear or side of the waist or head band and includes a switch, that is finger activated by the wearer, to turn on or off the LED light array. So arranged, the number of the array of LED lights is selected such that, when turned on, will illuminate approximately a 180 degree of arc ahead of the wearer with little or no bounce as the wearer walks or rides a bicycle, or the like, along a road, path or trail.

### DESCRIPTION OF THE DRAWINGS

In the drawings that illustrate that which is presently regarded as the best mode for carrying out the invention:

FIG. 1 is a frontal perspective view taken from slightly above a 180 degree light of the invention showing a belt that has end connectors and mounts a sleeve for containing a battery that includes, on one end, an off-on button and a connector plug, which plug is for receiving a connector end of an electrical cable that extends out from an end of a band that mounts a strip of electrically connected LED type lights, and shows the band as including a section of a coupling material attached thereto that joins with a comparable coupling material that is attached to a forward portion of the belt;

FIG. 2 is a frontal perspective view of the assembled components of the 180 degree light of FIG. 1;

FIG. 3A shows the belt of FIGS. 1 and 2 fitted around the forehead of a man, and showing the band as mounting the strip of LED lights that extends from above and slightly forward of one of the wearer's ears to their other ear;

FIG. 3B is a side elevation view of the person of FIG. 3A showing the strip of LED lights as illuminating the area ahead of and off to the sides of the man;

FIG. 4 shows a frontal perspective view of a woman runner wearing the belt of the 180 degree light around her waist;

FIG. 5 shows a perspective sectional view of the back of the belt worn by the woman in FIG. 5, and shows, in solid lines, the belt ends as including male and female couplings, and shows, in broken lines, the male and female coupling as having been joined together; and

FIG. 6 is an electrical schematic showing the electrical components of the 180 degree light and shows the strip of LED lights mounted onto the strap and shows the LED lights each electrically connected through a cable to the battery whereby, should one or more LED lights in the strip burn out, the remaining LED lights will still illuminate when electrically energized.

### DETAILED DESCRIPTION

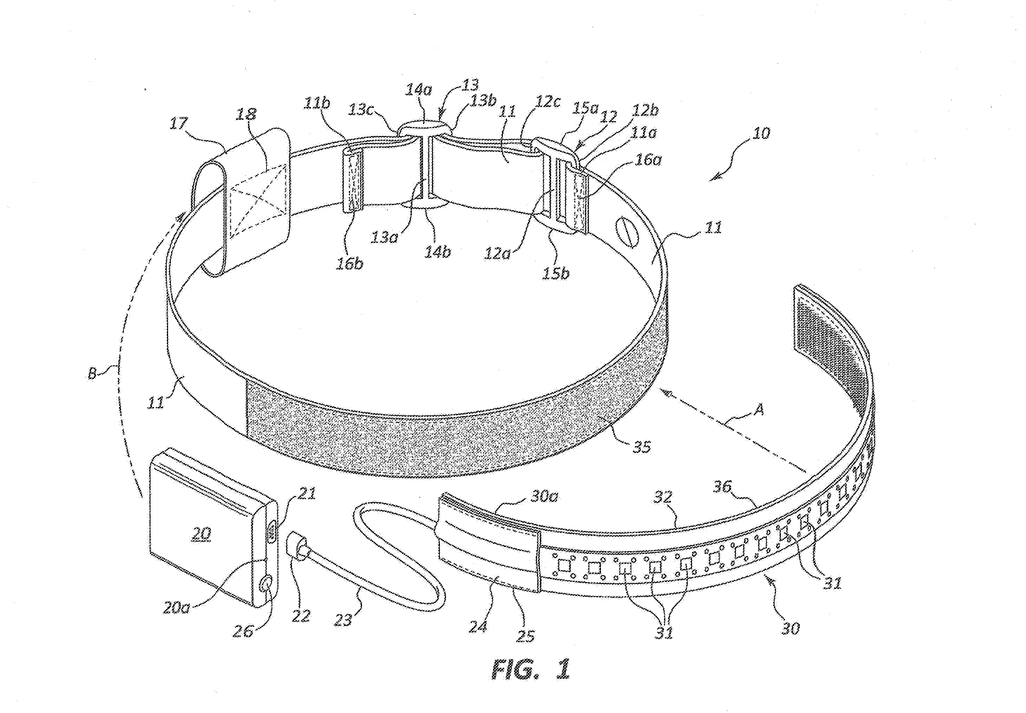

FIG. 1 shows a side elevation perspective view of a 180 degree light 10 of the invention as including a belt 11 having a slide end 12 on one end of the belt 11 and a length adjustment slide 13 on the other belt 11 end. Which slide end 12 and length adjustment slide 13 allow for an adjustment of the belt 11 length to fit comfortably around a wearer's head. A sleeve 17 is shown attached by threads 18 to the belt 11 that is to receive a battery 20 maintained therein that is electrically connected to a strip 30 of LED lights 31, providing power to which LED lights, as set out below.

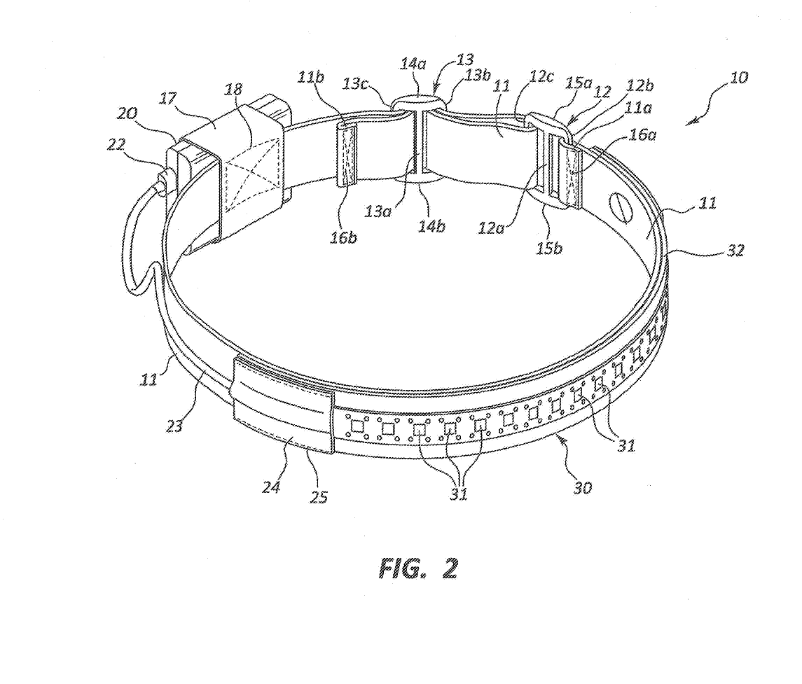

The slide end 12, as shown in FIGS. 1 and 2, has a rectangular shape with a center bar 12a extending between parallel top and bottom ends 14a and 14b, respectively, and which center bar 12a, from a clockwise perspective, is spaced equidistantly apart from first and second straight bar ends 12b and 12c, respectively of the slide end 12, providing gaps therebetween. As shown, the belt 11 end 11a, after travel through the slide end 12, is fitted through the gap between the slide end 12 center bar 12a and straight bar end 12b, and is bent back upon itself and coupled to the belt 11 surface with stitches 16a that permanently couple the slide end 12 to the belt end 11a.

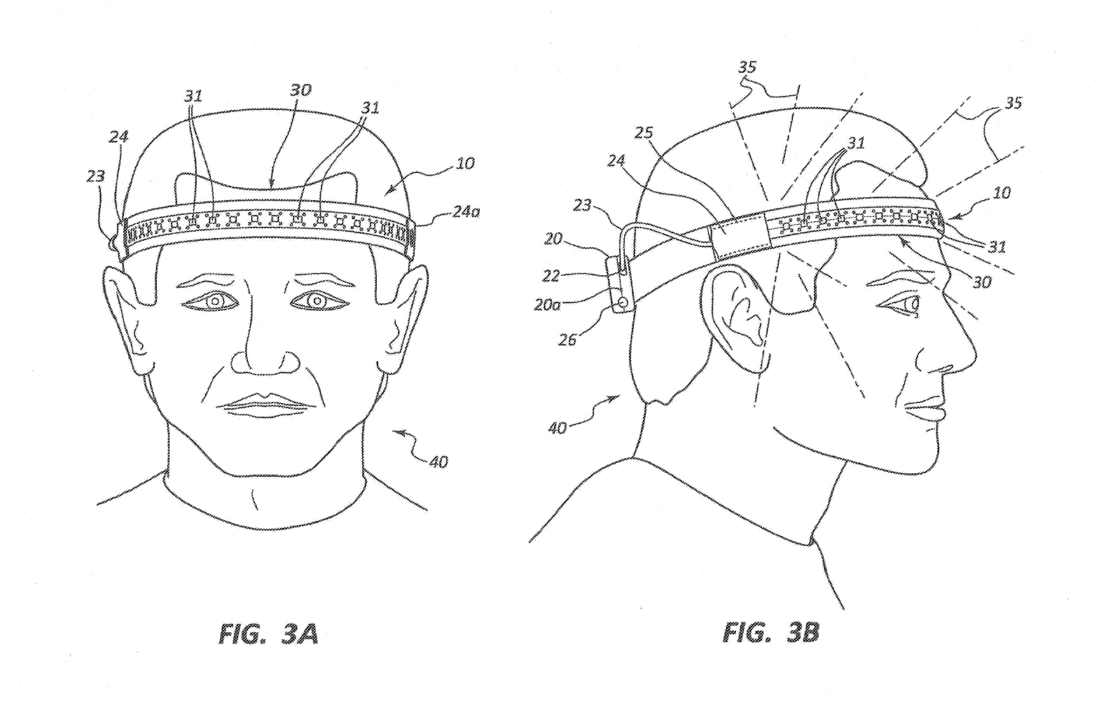

Also shown in FIGS. 1 and 2, the end 11b of belt 11 has been passed through the slide end 12 gap between the center bar 12a and second straight bar end 12c, has then been fitted through the length adjusting slide 13, traveling beneath itself, and is fitted through the gap between a center bar 13a of the length adjusting slide 13 and a first straight bar end 13b. The belt 11 end 11b is then shown as having traveled above and across the center bar 13a, and has passed through a gap between the center bar 13a and a second straight bar end 13c. So arranged, for adjusting the length of the belt 11 to fit around a wearer's head, as shown in FIGS. 3A and 3B, the belt end 11b, that has been folded upon itself and stitched at 16b to provide an end that is easily gripped, is threaded through the length adjusting slide 13, passing over the center bar 13a, and, from a clockwise perspective, is passed through the slide end 12 gap between the second straight bar end 12c, is bent upon itself, is fitted through the length adjusting slide 13, and travels through the gap between the center bar 13a and the first straight bar end 13b, passing across the center bar 13a, and out of the gap between the center bar 13a and the second straight bar end 13c. So arranged, by loosening the belt 11, as by pulling it appropriately through the respective length adjusting slide 13 and slide end 12, to first loosen the belt 11 between with length adjusting slide 13 and slide end 12, the belt 11 can then be pulled through the length adjusting slide 13. Where, when a desired length of belt 11 is obtained, a pulling of the length adjusting slide 13 away from the slide end 12, re-tightens the belt through the length adjusting slide and slide end 12, so as to maintain the desired length of belt 11 to fit around the wearer's neck.

With the belt 11 adjusted, as set out above, to fit the wearer's head, and before the belt is positioned onto the wearer's head, as shown in FIGS. 3A and 3B, the battery 20, that is preferably a rechargeable cell phone type battery, is electrically coupled to the strip 30 of LED lights 31 by fitting an electrical plug 22 into a socket 21 mounted to the battery 20 end. Whereafter, the battery 20 is fitted into sleeve 17, as shown in FIG. 2. Which electrical coupling provides for a transmission of electrical current through cable 23 and into the array of LED lights 31 that are each mounted, in a single line, at equal spaced intervals, along the strip 30 that are individually connected to simultaneously illuminate when a button 26, that is mounted onto the battery 20 end 20a, is depressed as by the wearer's finger. Thereafter, after a first depression of the button 26 to turn on the LED lights 31, a second depression of the button 26 will turn off the array of LED lights 31.

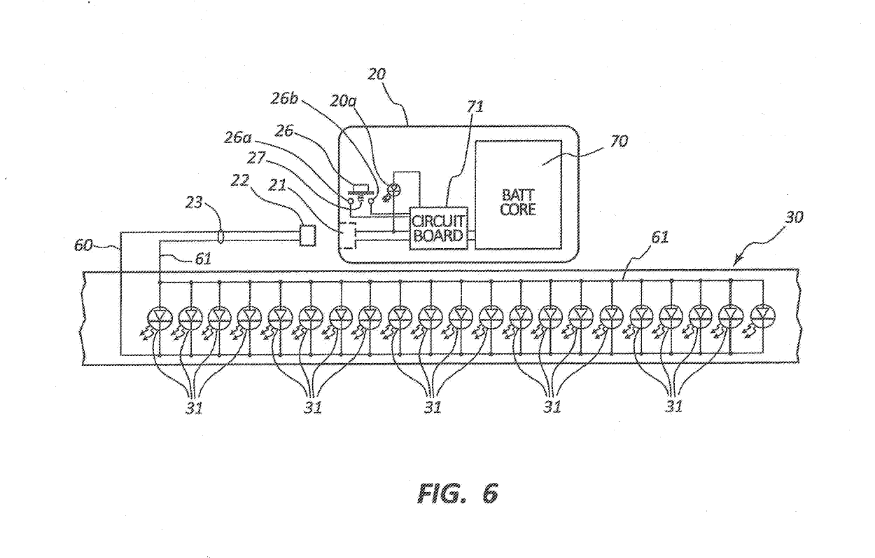

In practice, as shown is FIG. 1 and FIG. 6, the strip 30 is flexible and is preferably arranged to be water tight to protect the electrical junctions of the individual LED lights 31 with the wires contained within the cable 23. To maintain a water tight environment to the electrical connections of the LED lights 31, a the cover 24 is connected to the strip 30 to cover over and protect which electrical connections to the individual LED lights 31, with a like cover 24a fitted over the opposite strip 30 end. Which mountings of the cover 24 to the strip 30 end protects the electrical connection of wires within the cable 23 junction with the straight line of individual LED lights 31, as set out in FIG. 6. Which covers 24 and 24a, as shown in FIGS. 1 and 2, are mounted over the strip ends by sewing the covers 24 and 24a edges to the strip 30 ends by stitches 25. In practice, the strip 30 is fitted onto the band 32 for releaseable fitting to the belt 11 forward face that has a first section of a fastener material 35, such as a Velcro type matt material fixed thereto, that, as indicated by a broken arrow, is to receive a second section of a fastener material 36, such as a Velcro type hook material connected to the back of the band 32. So arranged, the band 32 is releasably attached to the belt 11 forward face when the second section of fastener material 36 is aligned with, and pressed against, the first section of fastener material 35, as illustrated by an arrow A. With the arrangement of the band 32, strip 30 and end covers 24 and 24a providing a water tight sealing of the wires that connect to each of the array of individual LED lights 31, as shown in FIG. 6.

FIG. 2 is a view like that of FIG. 1 only showing the strip 30 mounted to the forward face of the band 32 that includes the second section of fastener material 36 secured to its rear face, as shown in FIG. 1, has been pressed into the first section of fastener material 35, coupling the band 32 and strip 30 to the first section of fastener material secured to the forward face of the belt. Additionally, the plug 22 on the end of cable 23 is shown connected into the socket 21 on the end of the battery 20 that, as shown by arrow B, is fitted into the sleeve 17, completing the assembly of the 180 degree light 10 such that, with the depression of the button 26, the individual LED lights 31 of the 180 degree light 10 can be turned off and on.

FIG. 3A shows a front view of a man 40 wearing the 180 degree light 10 around his forehead, showing the positioning of the strip 30 of LED lights 31 in a horizontal line parallel to the ground, with the cable 23 and covers 24, as shown in FIGS. 1 and 2. FIG. 3B also shows the man 40 who has turned to his left and the straight line of individual LED lights 31 are illuminated sending out rays of light 35. The covers 24 forward ends are positioned over the ends of the strip of LED lights 31 and, as shown in FIG. 2, approximately align with the mans' ear lobe, providing, as illustrated by rays of light 35 from the straight line of individual LED lights 31 as illuminating the ground below and in front of the man 40, providing a lighting of approximately a full half circle in front of and to the sides of the man 40. In practice, as the length of the strip 30 is constant and with differences in head circumference the area of illumination of the single line of equally spaced LED lights 31 will vary from one hundred ninety degrees to one hundred seventy degrees in ahead and in front of and of the sides of the man 40.

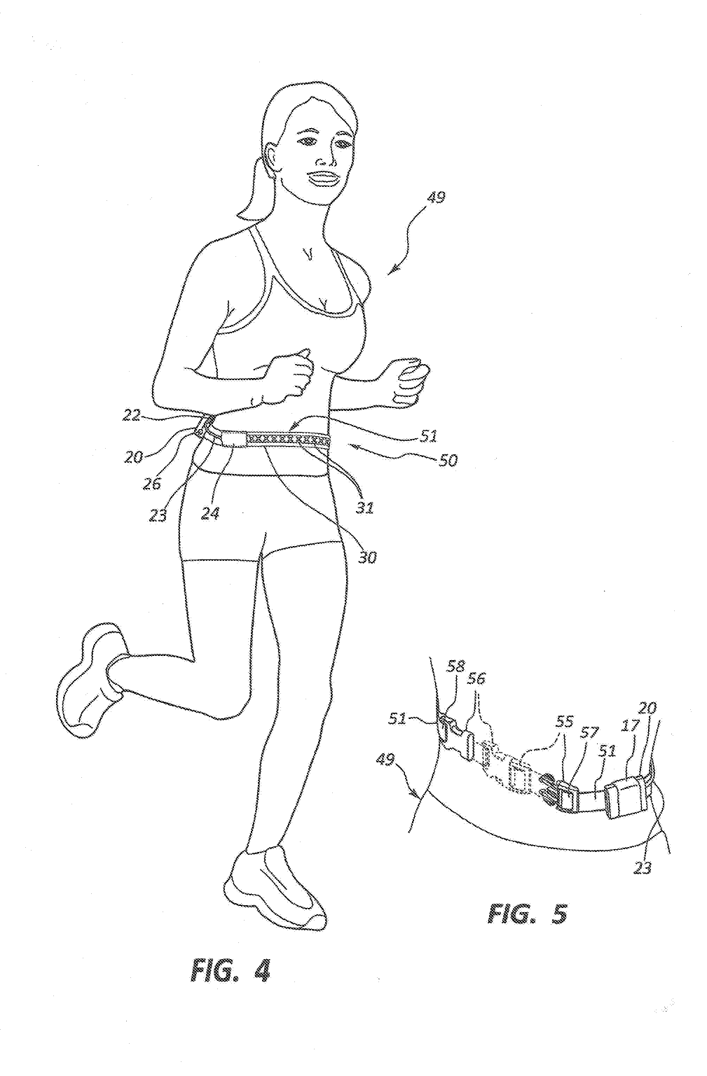

FIG. 4 shows a second embodiment of the LED light 50 of the invention as being worn around the waist of a woman 49. Rather than the head belt 30 of FIGS. 1 through 3B, the LED light 50 is shown as incorporating a waist belt 51 that includes the strip 30 that has a cover 24 on one end, includes the cable 23 and battery 20 that has the cable 23 with connector 22 that fits into an electrical socket 22 on the end of the battery 20 that includes the button 26. Functionally, the single straight line of individual LED lights 31 is the same for the LED light 10 and 50 with the distinction between the two being the belt 51 arrangement for length adjustment. Specifically, as shown in FIG. 5, the belt 51 is in two sections that are joined behind the wearer's back with male and female connectors 55 and 56, respectively, that couple when pushed together. For adjusting the length of the belt 51 sections an end of each is attached to the band 30, beneath the cover 24, and the opposite end of each belt 51 is threaded through a center opening of, respectively, slides 57 and 58 that are each connected to ends, respectively, of the male and female connectors 55 and 56, respectively. So arranged, the belt 51 ends are each fitted into one each of the slides of the male and female connectors, passing over and around center bar of each slide and back upon itself to set a desired length of the two belts 51 such that, when the male and female connectors 55 and 56, respectively, are pushed together the combined length of the two belts 51, will provide a comfortable fit around a wearer's waist, as illustrated in FIG. 4.

FIG. 6 shows an electrical schematic of the electrical components of the 180 degree light 30. Shown therein, The individual LED lights 31 are shown as a single line or equal spaced individual LED lights 31 that are connected between conductive wires 60 and 61, as a parallel connection, whereby, should one or more of the individual LED light 31 burn out, the remaining LED lights 31 will continue to illuminate when electrical current is passed through wires 60 and 61. Also therein the cable 23 is shown as containing the conductive wires 60 and 61 that connect to the plug 22 that is aligned for fitting into the socket 21, shown in broken lines. Which socket 21 is shown as connecting to wires that connect to a circuit board 71 that is wired to a system light 20a and back to a conductive wire. The system light 20a is thereby arranged to illuminate when power is passing to the strip of LED lights 30. Which circuit board 71 it also shown connected to a battery core 70 for powering the array of individual LED lights 31. Also, the button 26 is shown as being spring biased by a coil spring 27 away from poles 26a and 26b whereby, when the button 26 is pressed a connection is made to the circuit board to pass electrical current from the battery core 71 into the wires 60 and 61. Which connection to pass electrical current is maintained until the button 26 is pressed again, breaking the connection in the circuit board. With a depression and release of the button 26 to provide for turning on and turning off the array of LED lights 31.

Herein above has been shown and described a preferred embodiment of the 180 degree light of the invention. It should, however, be understood that the present disclosure is made by way of example only and that variations are possible without departing from the subject matter coming within the scope of the following claims and a reasonable equivalency thereof, which subject matter we regard as out invention.

We claim:

1. A 180 degree light comprising, a belt with end connection means for joining the belt ends together to fit around a wearer and connect to a band for mounting to a forward portion of said belt; a strip with means for mounting it onto said band that has a length that is selected to fit around front of the wearer, forming approximately a half circle, and said strip mounts an array of individual LED lights arranged in a straight line and in equal spaced in side by side relationship, that are horizontal to the ground the wearer stands on, and are electrically connected to a battery power source to illuminate approximately an arc of from one hundred ninety to one hundred seventy degrees in front of the wearer of said belt; and switch means for electrically connecting said battery to said array of individual LED lights to said battery power source.

2. The 180 degree light as recited in claim 1, where the band is arranged for connection around a wearer's head.

3. The 180 degree light as recited in claim 1, where the band is arranged for connection around mid-section of a wearer's body.

4. The 180 degree light as recited in claim 1, wherein the battery power source is sized for mounting in a sleeve connected to the belt so as to be accessible for a wearer to reach with their finger while wearing said belt; and said battery power source includes a switch means for operation by said wearer to turn on and off power to the array of individual LED lights,

5. The 180 degree light as recited in claim 1, wherein the individual LED lights are electrically connected in parallel.

6. The 180 degree light as recited in claim 1, wherein the strip that has the array of individual LED lights mounted thereto is arranged to be washable.
